(19) United States
(12) Patent Application Publication
(10) Pub. No.: US 2010/0268913 A1
(43) Pub. Date: Oct. 21, 2010

(54) LITHOGRAPHIC APPARATUS, CONTROL SYSTEM, MULTI-CORE PROCESSOR, AND A METHOD TO START TASKS ON A MULTI-CORE PROCESSOR

(75) Inventors: Robert Lambertus Cornelius Johannes VAN HALDER, Kaatsheuvel (NL); Wilhelmus Theodorus Maria Alberts, Steyl (NL); Richard Nauber, Gera (DE)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/726,396

(22) Filed: Mar. 18, 2010

Related U.S. Application Data
(60) Provisional application No. 61/169,589, filed on Apr. 15, 2009.

(51) Int. Cl. G06F 15/76; G06F 9/02

(52) U.S. Cl. 712/29; 712/E09.002

(57) ABSTRACT

A multi-core processor includes two or more cores; an external communication facility that is shared by the cores and is capable of communicating with one of the cores at a time; and an internal communication facility capable of communicating simultaneously with each one of the cores; wherein the multi-core processor is configured to: receive a first signal via the external communication facility; relay the first signal to one of the cores; handle the first signal by the one of the cores, thereby generating a second signal; transmit substantially at the same time the second signal to each one of the cores by the internal communication facility; start a task on each one of the cores in response to the receiving of the second signal.

### CROSS REFERENCE TO RELATED APPLICATIONS

This application claims priority and benefit under 35 U.S.C. §119(e) to U.S. Provisional Patent Application No. 61/169,589, entitled “Lithographic Apparatus, Control System, Multi-Core Processor, And A Method To Start Tasks On A Multi-Core Processor”, filed on Apr. 15, 2009. The content of that application is incorporated herein in its entirety by reference.

### FIELD

The present invention relates to a multi-core processor, a control system including such a multi-core processor, a lithographic apparatus including such a control system, and a method to start tasks on a multi-core processor.

### BACKGROUND

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

The lithographic apparatus may include multiple control systems or controllers which each control a process in the lithographic apparatus, e.g. motion control of a substrate table, image processing, etc, etc. Most modern control systems include a processor to calculate a controller output in dependency of an input, usually a sensor input. The calculation process of the processor is divided in equally spaced periods in which a signal, also called an interrupt, is sent to the processor, calculations are done, and the result of the calculation is sent from the processor to some IO-device like an amplifier. The equally spaced period is necessary to have a stabile process controller and is also known as the sample time. The sample time is dependent on the process to be controlled and the desired accuracy and may alternatively be defined as the sample frequency which is the inverse of the sample time. The interrupt is a signal caused by an external device, for instance a dedicated central clock or hardware of the control system, such as a sensor/camera. The external device is thus no part of the multi-core processor.

Within a sample period, the computational workload can be divided into a time-critical workload, referred to as sample calculations, and a non time-critical workload, referred to as background calculations. The priority of the sample calculations is set to be higher than the priority of the background calculations, so that the sample calculations interrupt the background calculations on a processor after receiving an interrupt.

Increasing demands in process control due to the increased complexity of the controller incorporated on the processor and/or the increase in control loop frequency, i.e. increase in sample frequency, have caused a need to increase the calculation capacity of processors, which can not be met by single-core processors. Instead, multi-core processors are used. Multi-core processors include at least two cores which can perform tasks at the same time.

A schematic representation of a prior art multi-core processor MCP is shown in FIG. 2. The multi-core processor in FIG. 2 has, by way of example, three cores C1, C2, and C3. The multi-core processor MCP includes an external communication facility ECF that is shared by all cores C1, C2, C3 and is capable of communicating with one of the cores at a time, as is schematically indicated by a switch SW.

An interrupt transmitted by a device ED, for instance a timing device such as a central clock, or a sensor, is received via the external communication facility ECF. However, with the external communication facility ECF, the interrupt can not be routed to all cores C1, C2, C3 at the same time, as mentioned before. In this example, the external communication facility ECF will route, i.e. relay, the interrupt to the second core C2. The cores C1, C2, C3 also have an output as indicated by the arrows to the right.

FIG. 3 shows a prior art method to start tasks T on the cores of the prior art multi-core processor MCP of FIG. 2. At time instant t0 the device ED of FIG. 2 transmits a signal. The cores C1-C3 may perform background calculations BG. The signal is received via the external communication facility ECF of FIG. 2, and, in this example, core C2 will handle the signal and start a scheduling process S at time instant t1 to schedule and start the tasks T on the different cores C1-C3. In this example, a task T is first started on core C1 where it interrupts a background calculation BG at time instant t2, subsequently a task T is started on core C3 where it interrupts a background calculation BG at time instant t3, and finally the scheduling process S stops at time instant t4 to start a task T on core C2 itself.

When a task T is finished, the background calculation BG may resume. At time instant t5 all tasks are finished. Due to the sequential starting of the tasks and the time (t1-t4) it takes for an operating system like Windows or Linux to handle the signal and schedule the tasks on each core, the time period between t0 and t5 is relatively long, or a limited amount of calculations within each task T can be performed (i.e. task T is short). The prior art method is thus limiting the calculation capacity, i.e. the efficiency, of the multi-core processor. Furthermore, with the conventional multi-core processor, when the number of cores increases, the effect gets worse.

Further, it may be desired from a control point of view to end the tasks or a portion of those tasks at substantially the same time, so that an output of the multi-core processor can be synchronized and no phase is lost in the control loop due to the calculation process of the multi-core processor. However, this can not be realized with the prior art method.

The abovementioned short-comings limit the performance of the control systems and thereby limit the overall performance of the lithographic apparatus.

### SUMMARY

It is desirable to increase the efficiency of multi-core processors. It is further desirable to improve the control of processes in a lithographic apparatus. It is further desirable to improve the performance of a lithographic apparatus.

According to an embodiment of the invention, there is provided a multi-core processor including two or more cores; an external communication facility that is shared by the cores and is capable of communicating with one of the cores at a time; and an internal communication facility capable of communicating simultaneously with each one of the cores; wherein the multi-core processor is configured to: receive a first signal via the external communication facility; relay the first signal to one of the cores; handle the first signal by the one of the cores, thereby generating a second signal; transmit substantially at the same time the second signal to each one of the cores by the internal communication facility; start a task on each one of the cores in response to the receiving of the second signal.

According to another embodiment of the invention, there is provided a control system to control a process in a lithographic apparatus, including a multi-core processor to calculate an output of the control system based on an input of a device, wherein the multi-core processor includes: two or more cores; an external communication facility that is shared by the cores and is capable of communicating with one of the cores at a time; and an internal communication facility capable of communicating simultaneously with each one of the cores; wherein the multi-core processor is configured to: receive a first signal via the external communication facility; relay the first signal to one of the cores; handle the first signal by the one of the cores, thereby generating a second signal; transmit substantially at the same time the second signal to each one of the cores by the internal communication facility; start a task on each one of the cores in response to the receiving of the second signal.

According to yet another embodiment of the invention, there is provided a lithographic apparatus including a control system to control a process in the lithographic apparatus and a sensor to provide an input to the control system based on the process, the control system including a multi-core processor to calculate an output of the control system based on the input of the sensor, wherein the multi-core processor includes: two or more cores; an external communication facility that is shared by the cores and is capable of communicating with one of the cores at a time; and an internal communication facility capable of communicating simultaneously with each one of the cores; wherein the multi-core processor is configured to: receive a first signal via the external communication facility; relay the first signal to one of the cores; handle the first signal by the one of the cores, thereby generating a second signal; transmit substantially at the same time the second signal to each one of the cores by the internal communication facility; start a task on each one of the cores in response to the receiving of the second signal.

According to a further embodiment of the invention, there is provided a method of starting tasks on cores of a multi-core processor including an external communication facility that is shared by the cores, the external communication facility being capable of communicating with one core at a time, and an internal communication facility being capable of communicating simultaneously with each one of the cores, the method including: receiving a first signal via the external communication facility; relaying the first signal to one of the cores; handling the first signal by the one of the cores, thereby generating a second signal; transmitting substantially at the same time the second signal to each one of the cores by the internal communication facility; starting the tasks on each one of the cores in response to the receiving of the second signal.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a prior art multi-core processor;

FIG. 3 depicts a schematic representation of a prior art method of starting tasks on the prior art multi-core processor of FIG. 2;

FIG. 4 depicts a multi-core processor according to an embodiment of the invention;

FIG. 5 depicts a method to start tasks on the cores of the multi-core processor of FIG. 4.

### DETAILED DESCRIPTION

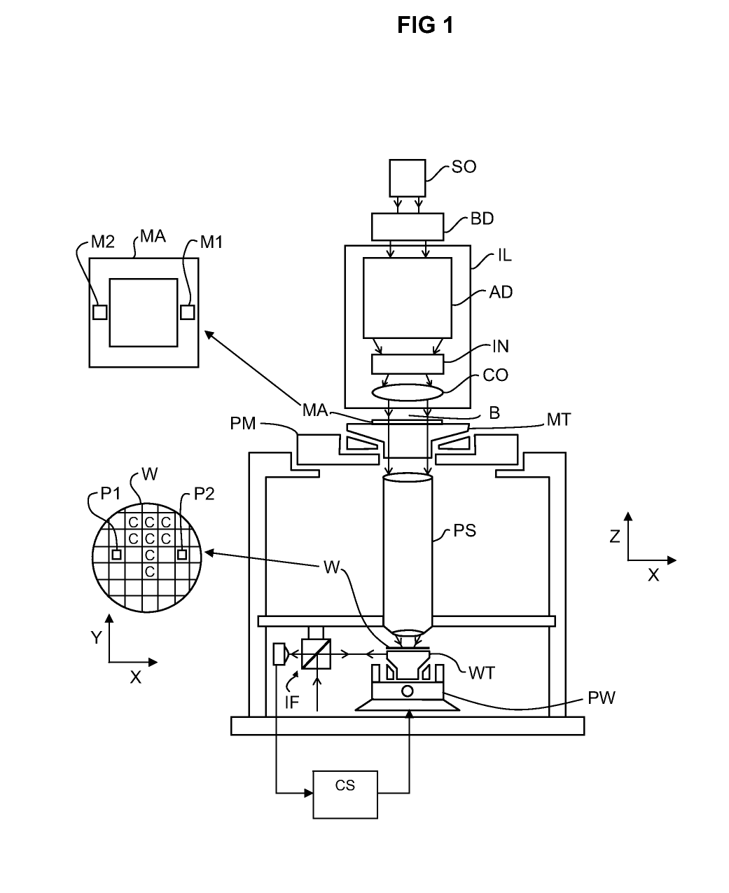

FIG. 1 schematically depicts a lithographic apparatus according to one embodiment of the invention. The apparatus includes an illumination system (illuminator) IL configured to condition a radiation beam B (e.g. UV radiation or any other suitable radiation), a patterning device support or mask support structure (e.g. a mask table) MT constructed to support a patterning device (e.g. a mask) MA and connected to a first positioning device PM configured to accurately position the patterning device in accordance with certain parameters. The apparatus also includes a substrate table (e.g. a wafer table) WT or “substrate support” constructed to hold a substrate (e.g. a resist-coated wafer) W and connected to a second positioning device PW configured to accurately position the substrate in accordance with certain parameters. The apparatus further includes a projection system (e.g. a refractive projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The patterning device support holds the patterning device in a manner that depends on the orientation of the patterning device, the design of the lithographic apparatus, and other conditions, such as for example whether or not the patterning device is held in a vacuum environment. The patterning device support can use mechanical, vacuum, electrostatic or other clamping techniques to hold the patterning device. The patterning device support may be a frame or a table, for example, which may be fixed or movable as required. The patterning device support may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables or “substrate supports” (and/or two or more mask tables or “mask supports”). In such “multiple stage” machines the additional tables or supports may be used in parallel, or preparatory steps may be carried out on one or more tables or supports while one or more other tables or supports are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the patterning device structure (e.g., mask table) MT, and is patterned by the patterning device. Having traversed the patterning device (e.g. mask) MA, the radiation beam B passes through the projection system PS, which focuses the beam onto a target portion C of the substrate W. With the aid of the second positioning device PW, control system CS, and position sensor IF (e.g. an interferometric device, linear encoder or capacitive sensor), the substrate table WT can be moved accurately, e.g. so as to position different target portions C in the path of the radiation beam B. Similarly, the first positioning device PM and another position sensor (which is not explicitly depicted in FIG. 1) can be used to accurately position the patterning device (e.g. mask) MA with respect to the path of the radiation beam B, e.g. after mechanical retrieval from a mask library, or during a scan. In general, movement of the patterning device support (e.g. mask table) MT may be realized with the aid of a long-stroke module (coarse positioning) and a short-stroke module (fine positioning), which form part of the first positioning device PM. Similarly, movement of the substrate table WT or “substrate support” may be realized using a long-stroke module and a short-stroke module, which form part of the second positioner PW. In the case of a stepper (as opposed to a scanner) the patterning device (e.g. mask table) MT may be connected to a short-stroke actuator only, or may be fixed. The control system CS is configured to provide a drive signal to the second positioning device PW based on an input from the position sensor IF. The drive signal being calculated periodically by a processor based on the input from the position sensor.

Patterning device (e.g. mask) MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the patterning device alignment marks may be located between the dies.

The depicted apparatus could be used in at least one of the following modes:

1. In step mode, the patterning device support (e.g. mask table) MT or “mask support” and the substrate table WT or “substrate support” are kept essentially stationary, while an entire pattern imparted to the radiation beam is projected onto a target portion C at one time (i.e. a single static exposure). The substrate table WT or “substrate support” is then shifted in the X and/or Y direction so that a different target portion C can be exposed. In step mode, the maximum size of the exposure field limits the size of the target portion C imaged in a single static exposure.

2. In scan mode, the patterning device support (e.g. mask table) MT or “mask support” and the substrate table WT or “substrate support” are scanned synchronously while a pattern imparted to the radiation beam is projected onto a target portion C (i.e. a single dynamic exposure). The velocity and direction of the substrate table WT or “substrate support” relative to the mask table MT or “mask support” may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the patterning device (e.g. mask table) MT or “mask support” is kept essentially stationary holding a programmable patterning device, and the substrate table WT or “substrate support” is moved or scanned while a pattern imparted to the radiation beam is projected onto a target portion C. In this mode, generally a pulsed radiation source is employed and the programmable patterning device is updated as required after each movement of the substrate table WT or “substrate support” or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

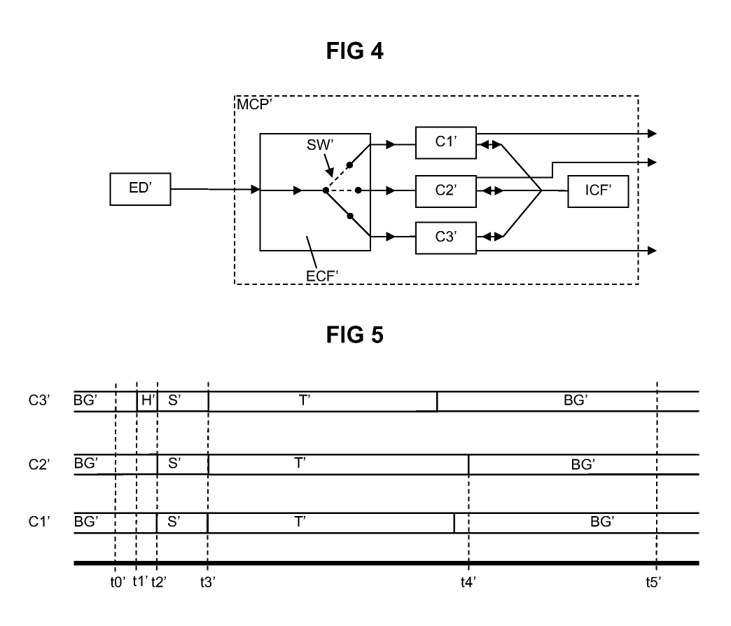

FIG. 4 depicts a schematic representation of a multi-core processor MCP′ according to an embodiment of the invention which can be used for instance in the control system or controller CS of the lithographic apparatus of FIG. 1. The multi-core processor MCP′ includes an external communication facility ECF′ which is shared by the cores C1′, C2′, C3′, and is capable of communicating with one of the cores at a same time, as is indicated by switch SW′. The external communication facility is connected to a device ED′, which can be a timing device such as a central clock, but may also be a sensor such as the position sensor IF of FIG. 1.

The multi-core processor MCP′ also includes an internal communication facility ICF′ being capable of communicating simultaneously with each one of the cores, for instance by multicasting.

The device ED′ is able to periodically send a first signal to the multi-core processor MCP′, which is received by the multi-core processor via the external communication facility ECF′. The external communication facility ECF′ is able to relay the first signal to one of the cores, in this case to core C3′. Core C3′ is then able to handle or process the first signal, thereby generating a second signal. The second signal is generated in a device (not shown) which is able to communicate with the cores via the internal communication facility, for instance a timer. The device may also be part of the internal communication facility. The internal communication facility is capable of transmitting at the same time the second signal to each of the cores. The cores are then able to locally start a task on each of the cores in response to the receiving of the second signal.

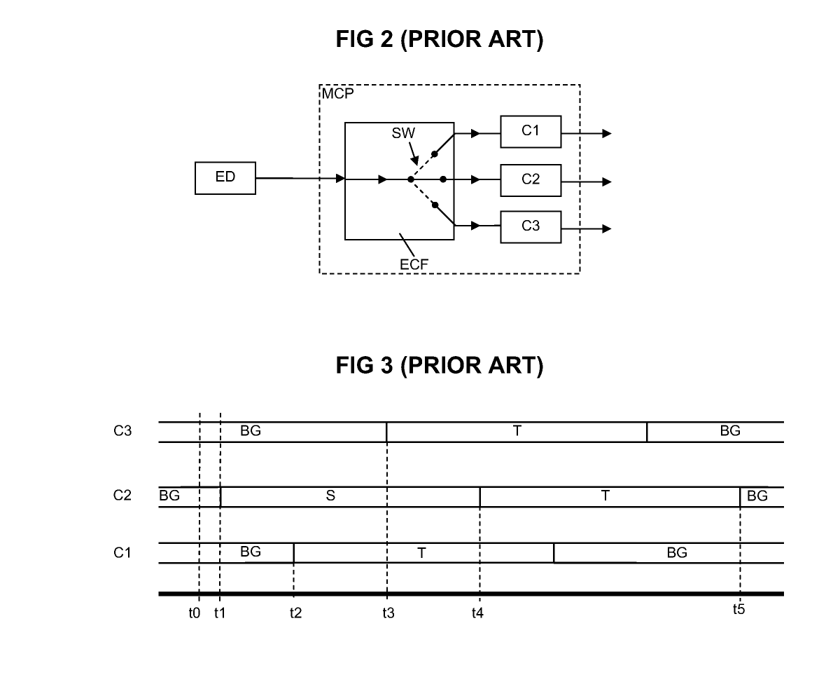

The cores C1′, C2′, C3′ also have an output as indicated by the arrows to the right, similar to the prior art multi-core processor MCP of FIG. 2.

FIG. 5 depicts a method according to an embodiment of the invention to start tasks T′ on cores C1′, C2′, C3′ of the multi-core processor MCP′ of FIG. 4. At time instant t0′, a first signal is received via the external communication facility ECF′, the first signal being transmitted by the device ED′. The cores C1′, C2′, C3′ may perform background calculation BG′. In this example, the first signal is relayed to core C3′, which handles the first signal between time instants t1′ and t2′ (indicated by block H) by starting a timer in the internal communication facility and set the timer to end at time instant t2′. At time instant t2′, the timer stops thereby generating a second signal which is transmitted substantially at the same time to each one of the cores by the internal communication facility. The receiving of the second signal starts similar scheduling processes (also known as interrupt service routines) S′ on each core, so that at time instant t3′ the tasks T′ start. The scheduling processes S′ on each core interrupt the background calculation BG′ on that core. In the embodiment of FIG. 5, the multi-core processor is configured to set a priority of the second signal to be higher than a priority of the first signal.

After a task T′ is finished, the background calculations may resume. At time instant t4′ all tasks T′ have finished, and for instance at time instant t5′ a next first signal may be received via the external communication facility so that the abovementioned steps of the method may be repeated periodically.

A benefit of the method according to an embodiment of the invention is that the tasks T′ are synchronized, which can be used to synchronize the output of the multi-core processor as well so that no phase is lost in a control loop due to the multi-core processor.

Another benefit is that the time interval between receiving of the signal from the external device and the moment the last task T′ is finished (t0′-t4′) is reduced. This allows smaller sample periods, or more calculations per sample period and thus increases the efficiency of the multi-core processor.

In an embodiment of the invention, the time interval between time instants t1′ and t2′ is as small as possible, as is the time interval between time instants t2′ and t3′.

Another benefit is that the time interval between time instants t1′ and t3′ is not depending on the number of cores on the multi-core processor, and is thus suitable for multi-core processors having a relatively large number of cores, which would also increase the calculation capacity without having to increase the sample period as well.

In an embodiment there is provided a multi-core processor including two or more cores and an external communication facility that is shared by the cores. The external communication facility is capable of communicating with one of the cores at a time. The multi-core processor further includes an internal communication facility capable of communicating simultaneously with each one of the cores. The multi-core processor is configured to receive a first signal via the external communication facility and relay the first signal to one of the cores. The multi-core processor is configured to handle the first signal by the one of the cores and thereby generating a second signal. The multi-core processor is configured to transmit substantially at the same time the second signal to each one of the cores by the internal communication facility and to start a task on each one of the cores in response to the receipt of the second signal.

The multi-core processor may be configured to start the task on all cores after receiving the second signal, including the core handling the first signal.

The multi-core processor may be configured to set a priority of the second signal to be higher than a priority of the first signal.

The internal communication facility may include a timer configured to generate the second signal.

In an embodiment there is provided a control system or controller to control a process in a lithographic apparatus. The control system includes a multi-core processor configured to calculate an output of the control system based on an input of a device. The multi-core processor includes two or more cores and an external communication facility that is shared by the cores and that is capable of communicating with one of the cores at a time. The multi-core processor further includes an internal communication facility capable of communicating simultaneously with each one of the cores. The multi-core processor is configured to receive a first signal via the external communication facility and relay the first signal to one of the cores. The multi-core processor is configured to handle the first signal by the one of the cores and thereby generating a second signal. The multi-core processor is configured to transmit substantially at the same time the second signal to each one of the cores by the internal communication facility and to start a task on each one of the cores in response to the receiving of the second signal.

The multi-core processor may be configured to start the task on all cores after receiving the second signal, including the core handling the first signal.

The multi-core processor may be configured to set a priority of the second signal to be higher than a priority of the first signal.

The multi-core processor may include a timer configured to generate the second signal.

In an embodiment there is provided a lithographic apparatus including a control system or controller and a sensor. The control system is to control a process in the lithographic apparatus. The sensor is to provide an input to the control system based on the process. The control system includes a multi-core processor configured to calculate an output of the control system based on the input of the sensor. The multi-core processor includes two or more cores and an external communication facility that is shared by the cores and that is capable of communicating with one of the cores at a time. The multi-core processor includes an internal communication facility capable of communicating simultaneously with each one of the cores. The multi-core processor is configured to receive a first signal via the external communication facility and relay the first signal to one of the cores. The multi-core processor is configured to handle the first signal by the one of the cores and thereby generating a second signal. The multi-core processor is configured to transmit substantially at the same time the second signal to each one of the cores by the internal communication facility and start a task on each one of the cores in response to the receiving of the second signal.

The multi-core processor may be configured to start a task on all cores after receiving the second signal, including the core handling the first signal.

The multi-core processor may be configured to set a priority of the second signal to be higher than a priority of the first signal.

The multi-core processor may include a timer configured to generate the second signal.

In an embodiment there is provided a method of starting tasks on cores of a multi-core processor. The multi-core processor includes an external communication facility that is shared by the cores and is capable of communicating with one core at a time. The multi-core processor includes an internal communication facility being capable of communicating simultaneously with each one of the cores. The method includes receiving a first signal via the external communication facility and relaying the first signal to one of the cores. The method includes handling the first signal by the one of the cores and thereby generating a second signal. The method includes transmitting substantially at the same time the second signal to each one of the cores by the internal communication facility and starting the tasks on each one of the cores in response to the receiving of the second signal.

A priority of the second signal may be set by the multi-core processor to be higher than a priority of the first signal. The second signal may be generated by a timer.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A multi-core processor comprising:
two or more cores;
an external communication facility that is shared by the cores and is capable of communicating with one of the cores at a time; and
an internal communication facility capable of communicating simultaneously with each one of the cores;
wherein the multi-core processor is configured to:
receive a first signal via the external communication facility;
relay the first signal to one of the cores;
handle the first signal by the one of the cores to generate a second signal;
transmit substantially at a same time the second signal to each one of the cores by the internal communication facility; and
start a task on each one of the cores in response to the receipt of the second signal.

2. The multi-core processor of claim 1, wherein the multi-core processor is configured to start the task on all cores after receiving the second signal, including the core handling the first signal.

3. The multi-core processor of claim 1, wherein the multi-core processor is configured to set a priority of the second signal to be higher than a priority of the first signal.

4. The multi-core processor of claim 1, wherein the internal communication facility comprises a timer configured to generate the second signal.

5. A control system to control a process in a lithographic apparatus, the control system comprising a multi-core processor configured to calculate an output of the control system based on an input of a device, wherein the multi-core processor comprises:
two or more cores;
an external communication facility that is shared by the cores and is capable of communicating with one of the cores at a time; and
an internal communication facility capable of communicating simultaneously with each one of the cores;
wherein the multi-core processor is configured to:
receive a first signal via the external communication facility;
relay the first signal to one of the cores;
handle the first signal by the one of the cores to generate a second signal;
transmit substantially at a same time the second signal to each one of the cores by the internal communication facility; and
start a task on each one of the cores in response to the receiving of the second signal.

6. The control system of claim 5, wherein the multi-core processor is configured to start the task on all cores after receiving the second signal, including the core handling the first signal.

7. The control system of claim 5, wherein the multi-core processor is configured to set a priority of the second signal to be higher than a priority of the first signal.

8. The control system of claim 5, wherein the multi-core processor comprises a timer configured to generate the second signal.

9. A lithographic apparatus comprising a control system to control a process in the lithographic apparatus and a sensor to provide an input to the control system based on the process, the control system comprising a multi-core processor configured to calculate an output of the control system based on the input of the sensor, wherein the multi-core processor comprises:
two or more cores;
an external communication facility that is shared by the cores and is capable of communicating with one of the cores at a time; and
an internal communication facility capable of communicating simultaneously with each one of the cores;
wherein the multi-core processor is configured to:
receive a first signal via the external communication facility;
relay the first signal to one of the cores;
handle the first signal by the one of the cores to generate a second signal;
transmit substantially at a same time the second signal to each one of the cores by the internal communication facility; and
start a task on each one of the cores in response to the receiving of the second signal.

10. The lithographic apparatus of claim 9, wherein the multi-core processor is configured to start a task on all cores after receiving the second signal, including the core handling the first signal.

11. The lithographic apparatus of claim 9, wherein the multi-core processor is configured to set a priority of the second signal to be higher than a priority of the first signal.

12. The lithographic apparatus of claim 9, wherein the multi-core processor comprises a timer configured to generate the second signal.

13. A method of starting tasks on cores of a multi-core processor comprising an external communication facility that is shared by the cores, the external communication facility being capable of communicating with one core at a time, and an internal communication facility being capable of communicating simultaneously with each one of the cores, the method comprising:
receiving a first signal via the external communication facility;
relaying the first signal to one of the cores;
handling the first signal by the one of the cores to generate a second signal;
transmitting substantially at the same time the second signal to each one of the cores by the internal communication facility; and
starting the tasks on each one of the cores in response to the receiving of the second signal.

14. The method of claim 13, wherein a priority of the second signal is set by the multi-core processor to be higher than a priority of the first signal.

15. The method of claim 13, wherein the second signal is generated by a timer.
